(19) United States
(12) Patent Application Publication
(10) Pub. No.: US 2025/0356846 A1
(43) Pub. Date: Nov. 20, 2025

(54) LLM-POWERED VOICE-TO-DATA DOCUMENTATION SYSTEM FOR FIELD INSPECTION AND INFRASTRUCTURE ASSESSMENT

(71) Applicant: NEC Laboratories America, Inc., Princeton, NJ (US)

(72) Inventors: Yangmin DING, East Brunswick, NJ (US); Ting WANG, West Windsor, NJ (US)

(73) Assignee: NEC Laboratories America, Inc., Princeton, NJ (US)

(21) Appl. No.: 19/204,563

(22) Filed: May 11, 2025

Related U.S. Application Data
(60) Provisional application No. 63/648,693, filed on May 17, 2024.
(60) Provisional application No. 63/648,695, filed on May 17, 2024.

(51) Int. Cl. G10L 15/18; G10L 15/01; G10L 15/30; G10L 21/02

(52) U.S. Cl. CPC G10L 15/18; G10L 15/01; G10L 15/30; G10L 21/02

(57) ABSTRACT

A large language model (LLM) powered voice-to-data documentation system and operating method for field inspection and infrastructure assessment which converts spoken language into precise, structured digital data in real-time and overcomes limitations of manual notetaking and data transcription by providing real-time, accurate interpretation of technical terminology and context, significantly reducing human error and enhancing data integrity. Our system and method provide immediate decision-making and problem-solving, markedly improving the speed and efficiency of infrastructure maintenance and compliance processes and may be portable, thereby permitting their use in challenging field environments, enabling inspectors to focus on critical assessment tasks without the distraction of cumbersome documentation procedures.

### CROSS-REFERENCE TO RELATED APPLICATIONS

This application claims the benefit of U.S. Provisional Patent Application Ser. No. 63/648,693 filed May 17, 2024, and U.S. Provisional Patent Application Ser. No. 63/648,695 filed May 17, 2024, the entire contents of each of which is incorporated by reference as if set forth at length herein.

### FIELD OF THE INVENTION

This application relates generally to infrastructure management and maintenance, including power grid infrastructure. More particularly, it pertains to large language model powered voice-to-data documentation for field inspection and infrastructure assessment.

### BACKGROUND OF THE INVENTION

As will be understood and appreciated, power grid infrastructure management that ensures the reliability, safety, and efficiency of the power network is of critical importance in contemporary society. A traditional approach to maintaining this intricate network involves extensive field inspections and assessments to identify and rectify potential issues before they escalate into critical failures. This traditional approach relies heavily on manual processes, including physical inspections of assets such as poles, lines, substations, and other infrastructure, resulting in the production of handwritten notes and later, digital reports.

### SUMMARY OF THE INVENTION

An advance in the art is made according to aspects of the present disclosure directed to a large language model (LLM) powered voice-to-data documentation system and method for field inspection and infrastructure assessment which advantageously introduces a transformative approach to field inspection and infrastructure assessment, directly addressing the critical inefficiencies of traditional grid management methods.

In sharp contrast to the prior art methodologies, and by leveraging advanced large language models (LLMs), our inventive systems and methods convert spoken language into precise, structured digital data in real-time. It overcomes limitations of manual notetaking and data transcription by providing real-time, accurate interpretation of technical terminology and context, significantly reducing human error and enhancing data integrity.

Further, our inventive systems and methods automatically analyze, contextualize, and summarize field data into actionable insights and comprehensive reports. Advantageously, this capability provides immediate decision-making and problem-solving, markedly improving the speed and efficiency of infrastructure maintenance and compliance processes.

Finally, our inventive systems and methods may be portable, thereby permitting their use in challenging field environments, enabling inspectors to focus on critical assessment tasks without the distraction of cumbersome documentation procedures.

### BRIEF DESCRIPTION OF THE DRAWING

FIG. 1 is a schematic diagram showing illustrative comparisons between traditional approach (left) and systems and methods (right) according to aspects of the present disclosure.

FIG. 2 is a schematic diagram showing illustrative LLM integration in a cloud service according to aspects of the present disclosure.

FIG. 3 is a schematic diagram showing illustrative LLM integration in an edge device according to aspects of the present disclosure.

FIG. 4 is a schematic flow diagram showing illustrative steps according to aspects of the present disclosure.

FIG. 5(A) and FIG. 5(B) show illustrative features in a hierarchical format of systems and methods according to aspects of the present disclosure.

FIG. 6(A) and FIG. 6(B) are schematic flow diagrams showing illustrative method steps according to aspects of the present disclosure.

FIG. 7(A) and FIG. 75(B) show illustrative features in a hierarchical format of additional systems and methods according to aspects of the present disclosure.

FIG. 8 is a schematic diagram showing illustrative computer system in which aspects of methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that in the realm of power grid infrastructure management, ensuring the reliability, safety, and efficiency of the network is paramount. As previously noted, traditional approaches to maintaining this intricate network involves extensive field inspections and assessments to identify and rectify potential issues before they escalate into critical failures. This conventional approach relies heavily on manual processes, including physical inspections of assets such as poles, lines, substations, and other hardware, followed by handwritten notes and later, digital report generation. As will be readily understood and appreciated, such an historical approach presents several inefficiencies.

### Time and Resource Intensive

Manual inspections and subsequent reporting are laborious, consuming considerable time and human resources, which could be better deployed on analysis and remediation.

### Prone to Errors

Handwritten notes are susceptible to inaccuracies due to misinterpretation, illegible handwriting, and transcription errors, compromising data integrity.

### Delayed Decision Making

The lag between data collection, report generation, and analysis slows down the decision-making process, delaying necessary interventions.

### Limited Real-Time Data Utilization

The inability to process data in real-time hinders the immediate assessment and response to detected issues, potentially leading to escalated situations.

### Safety Risks

The focus on manual documentation can distract from the immediate environment, increasing safety risks for field personnel in hazardous conditions.

As those skilled in the art will further understand and appreciate, the reliability of the power grid is crucial not just for individual consumers but for the economy at large, impacting everything from residential well-being to critical services and industrial operations. Failures within the power grid can have far-reaching consequences, including significant economic losses, safety hazards, and negative environmental impacts. Therefore, enhancing the efficiency, accuracy, and speed of field inspections is not merely an operational improvement but a critical need.

Furthermore, regulatory compliance demands meticulous documentation and reporting. As regulations become more stringent, the traditional methods of compliance reporting are becoming increasingly untenable, requiring more streamlined, accurate, and efficient solutions.

Addressing these challenges is vital for at least the following reasons.

### Enhancing Grid Reliability

Improved inspection processes lead to better maintenance, reducing the risk of failures and ensuring a stable power supply.

### Safety Improvements

Minimizing manual documentation allows inspectors to focus more on their surroundings, enhancing safety.

### Regulatory Compliance

Efficient and accurate data capture and reporting facilitate compliance with regulatory standards, avoiding penalties and ensuring operational integrity.

### Operational Efficiency

Streamlining the inspection process reduces operational costs, allows for better resource allocation, and improves response times to issues.

Accordingly, there exist clear and present needs to revolutionize the traditional methods of power grid infrastructure inspection and assessment. Innovations that can address these inefficiencies, improve safety, and ensure regulatory compliance are not just beneficial but essential for the sustainable and reliable operation of power grid systems. The systems and methods according to aspects of the present disclosure address these critical issues by leveraging advanced technologies to bring about a transformative improvement in the field inspection and infrastructure assessment process.

Our disclosed voice-to-data documentation system for field inspection and infrastructure assessment introduces a transformative approach to field inspection and infrastructure assessment, directly addressing the critical inefficiencies of traditional grid management methods. By leveraging advanced Large Language Models (LLMs), this portable device offers a solution for converting spoken language into precise, structured digital data on-the-spot. It overcomes the limitations of manual notetaking and data transcription by providing real-time, accurate interpretation of technical terminology and context, significantly reducing human error and enhancing data integrity.

Our systems and methods advance the state of the art by incorporating LLM technology to automatically analyze, contextualize, and summarize field data into actionable insights and comprehensive reports. This capability allows for immediate decision-making and problem-solving, markedly improving the speed and efficiency of infrastructure maintenance and compliance processes. Unlike existing technologies, our solution emphasizes portability and ease of use in challenging field environments, enabling inspectors to focus on critical assessment tasks without the distraction of cumbersome documentation procedures.

This LLM-powered documentation system represents a significant leap forward in infrastructure management technology. It not only addresses the pressing need for improved accuracy and efficiency in field inspections but also sets a new benchmark in leveraging AI for enhancing operational workflows, safety, and regulatory compliance in the energy sector.

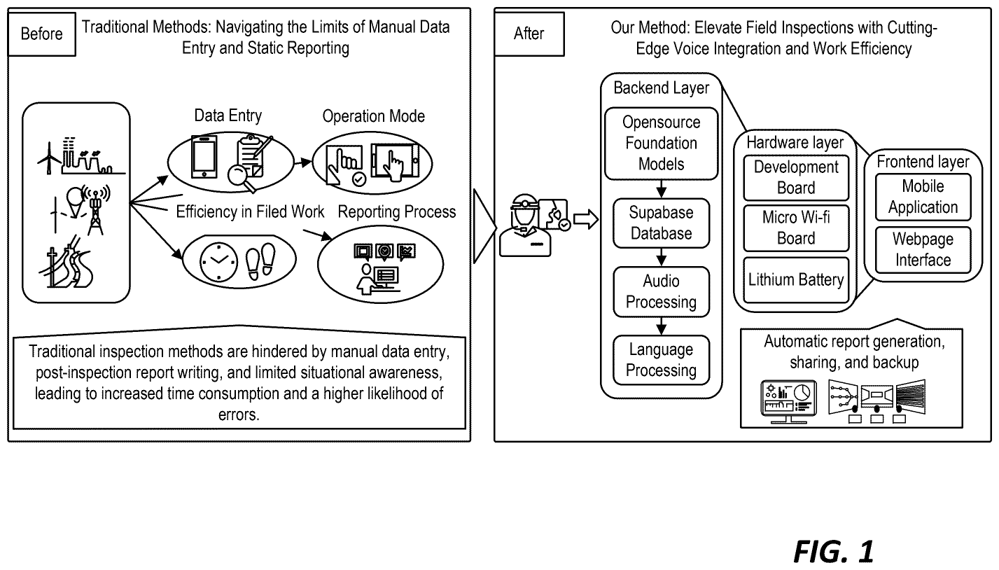

FIG. 1 is a schematic diagram showing illustrative comparisons between traditional approach (left) and systems and methods (right) according to aspects of the present disclosure.

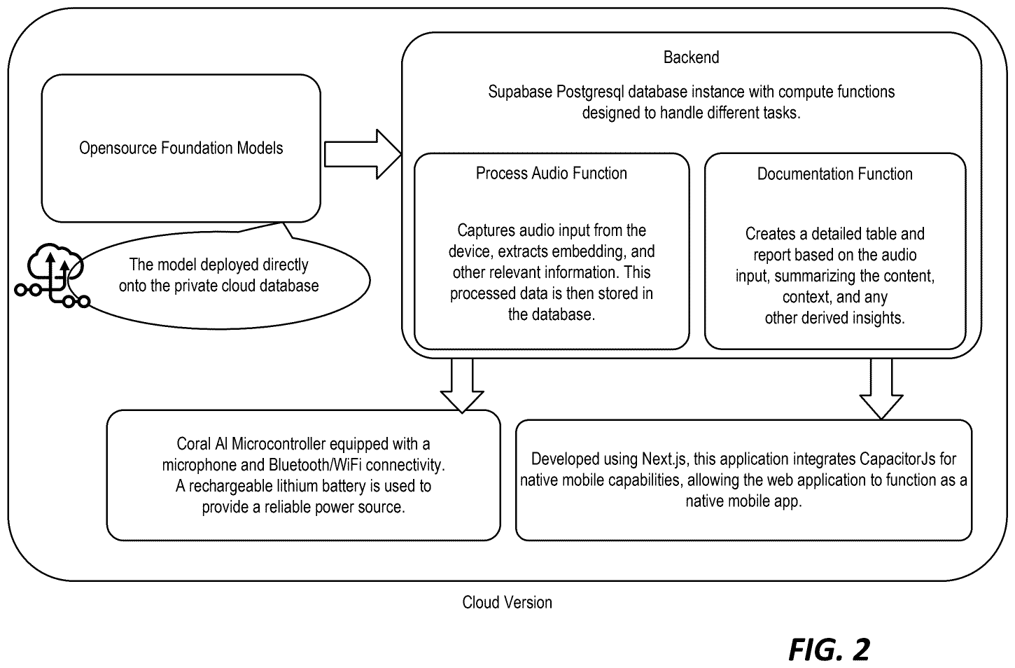

FIG. 2 is a schematic diagram showing illustrative LLM integration in a cloud service according to aspects of the present disclosure.

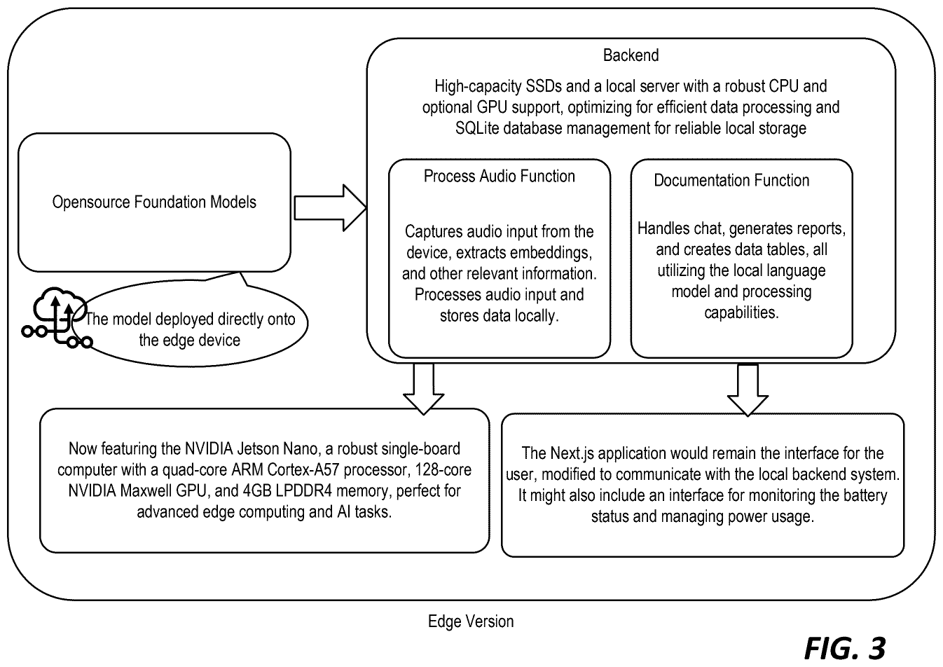

FIG. 3 is a schematic diagram showing illustrative LLM integration in an edge device according to aspects of the present disclosure.

As those skilled in the art will understand and appreciate, our inventive systems and methods according to aspects of the present disclosure incorporate several inventive features across its cloud and edge versions that collectively contribute to solving the inefficiencies in traditional grid management methods.

### For Both Cloud and Edge Versions

### Advanced LLM Integration

The system uses Large Language Models that are specifically trained on technical and industry-relevant data, ensuring high-precision interpretation of complex terminology and jargon used during field inspections.

### Real-Time Data Processing

Both versions are designed to process and analyze data in real-time. This allows for the immediate generation of reports and insights, accelerating the decision-making process and enabling quicker interventions.

### Automated Compliance Reporting

The system automatically formats the processed data into detailed reports that comply with industry regulations, significantly reducing the administrative burden and the potential for human error.

### Enhanced Portability

Emphasizing ease of use and portability, the device can be utilized in various field environments, allowing inspectors to focus on the inspection without the distraction of cumbersome documentation processes.

### Specific to the Cloud Version:

### Scalable Cloud Infrastructure

By leveraging cloud computing, the system can handle extensive datasets and perform complex computations that might not be feasible on local devices, offering scalability and power for data analysis.

### Continuous Learning and Updates

The cloud version can receive continuous updates and improvements, including LLM retraining, ensuring the system evolves and improves over time with new data and insights.

### Specific to the Edge Version

### Local On-Device Processing

Equipped with the NVIDIA Jetson Nano, the edge version can perform significant data processing tasks on the device itself, which is crucial for operations in areas with limited or no connectivity.

### Privacy and Security

With local processing and storage, the edge version offers enhanced data privacy and security by minimizing the need to transmit sensitive information over the network.

### Energy and Operational Efficiency

The edge version is optimized for low power consumption and is designed to manage battery life effectively, which is essential for prolonged field operations.

### Combining Cloud and Edge

### Hybrid Deployment Flexibility

The system can seamlessly switch between cloud and edge processing based on the availability of connectivity and the need for computational power, providing flexibility in deployment.

### Robust Data Management

With the capability to manage data both locally and in the cloud, the system ensures that information is always backed up and accessible when needed, enhancing data redundancy and reliability.

### Interoperability and Integration

The system is designed to integrate seamlessly with existing infrastructure management systems, facilitating the flow of information and the utility of data across various platforms and tools used by utilities.

By incorporating these features, our inventive voice-to-data documentation systems and method represents a significant innovation in field inspection technology, addressing the crucial need for improved accuracy, efficiency, and speed, while maintaining the flexibility to adapt to various operational environments and requirements.

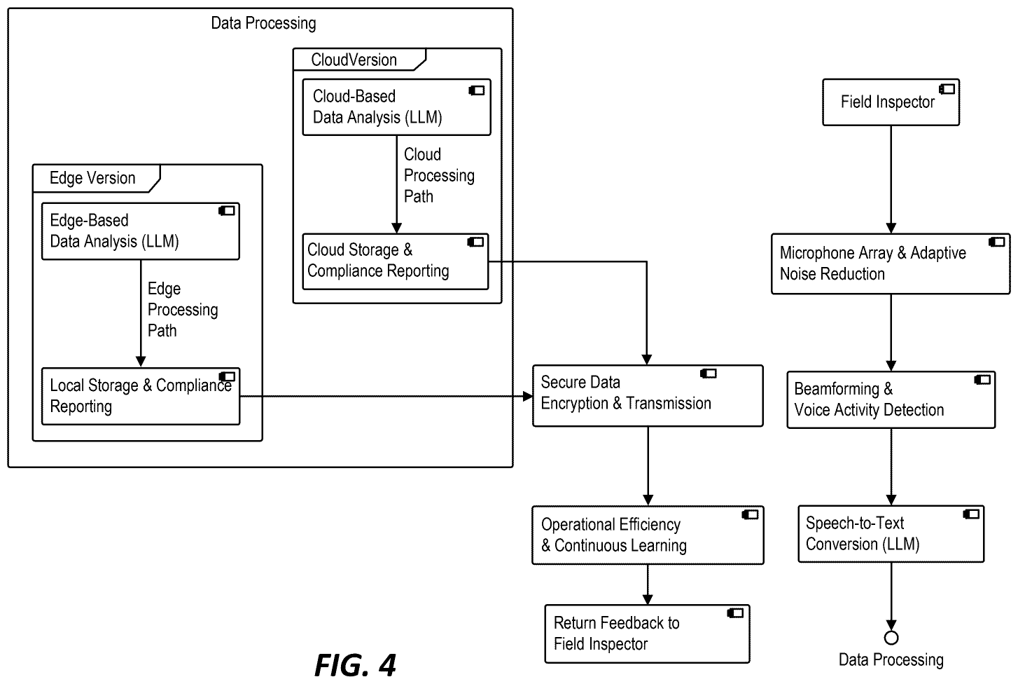

FIG. 4 is a schematic flow diagram showing illustrative steps according to aspects of the present disclosure.

A Step-by-Step description of our inventive method and system device operation is illustratively as follows

### Step 1: System Setup and Initialization

The computer implemented device is turned on and initializes its components. The advanced LLM integration begins with loading the model tailored for technical language. This ensures the system is prepared with the correct contextual understanding needed for field inspections.

### Step 2: Environmental Calibration

The device calibrates its audio capture system using real-time environmental noise assessment. The system uses adaptive algorithms for noise reduction and beamforming, optimizing audio capture settings for clear voice data collection in diverse environmental conditions.

### Step 3: Voice Data Capture

Action: Field technicians start their inspection and narrate their observations, which the device captures via its microphone array. Enhanced portability and ease of use allow for hands-free operation, letting inspectors focus on the inspection task without distractions.

### Step 4: Real-Time Data Processing

Action (Cloud Version): Captured audio is sent to the cloud for processing. Action (Edge Version): Audio data is processed locally on the device. Depending on the version, the system either leverages scalable cloud infrastructure for extensive processing or performs local on-device processing to ensure functionality even in low-connectivity areas.

### Step 5: Speech-to-Text Conversion

The audio data is converted into text by the LLM.

The system accurately transcribes spoken language, including technical terms, due to the LLM's specialized training.

### Step 6: Contextual Analysis and Summarization

The transcribed text undergoes analysis to extract key information and insights. Real-time data processing facilitates immediate creation of actionable insights and summaries, streamlining decision-making during field inspections.

### Step 7: Automated Compliance Documentation

The device formats the summarized data into detailed compliance reports. Automated compliance reporting reduces manual workloads and errors, ensuring that the documentation meets regulatory standards.

### Step 8: Secure Data Management and Transmission

(Cloud Version): Summaries and reports are encrypted and transmitted to the cloud for storage. (Edge Version): Data is encrypted and stored locally on the device. The dual-layer encryption protocol, whether in cloud or edge storage, maintains data integrity and confidentiality.

### Step 9: Data Accessibility and Integration

The processed data is made accessible for further analysis and integration into existing systems. The system's interoperability feature ensures that it can seamlessly integrate with other management platforms, enhancing the utility of collected data.

### Step 10: Continuous Learning and System Updates

The system receives feedback and updates to improve its models and functionalities. Continuous learning and updates (particularly in the cloud version) ensure the system remains current and improves its performance over time.

### Step 11: Operational Efficiency and Energy Management

The device manages its power usage and operational efficiency during fieldwork.

The edge version's optimized battery management ensures prolonged operation, crucial for extensive field inspections.

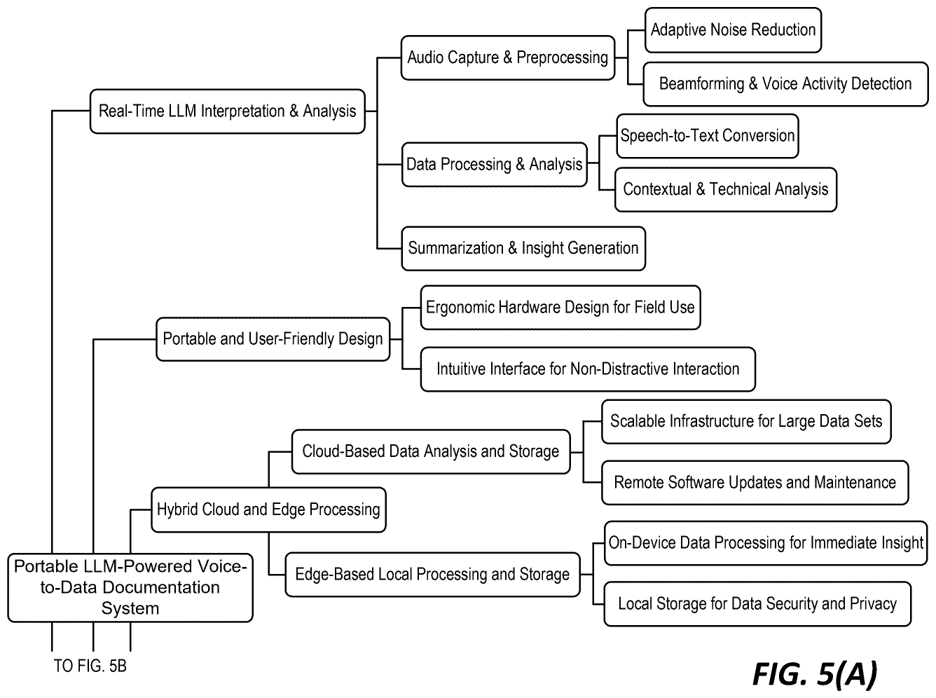

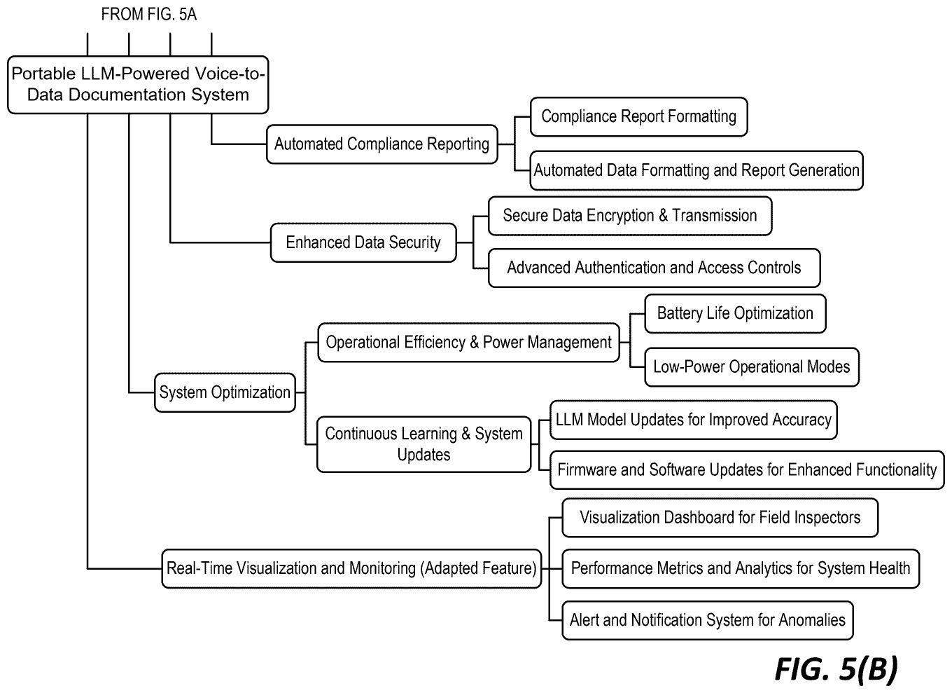

FIG. 5(A) and FIG. 5(B) show illustrative features in a hierarchical format of systems and methods according to aspects of the present disclosure.

As we have noted, our inventive systems and methods address several critical challenges and may now be extended into further domains including meeting documentation and analysis, particularly for offline or in-person meetings and conversations. A set of problems intended to solve in such domains are multifaceted and impact various stakeholders, from individuals and teams to organizations at large. Below is a description of the problem:

### Inefficiency in Manual Meeting Summarization

Traditional methods of meeting summarization are predominantly manual, requiring individuals to take notes or minutes during or after the meeting. This process is time-consuming, prone to errors and omissions, and often results in summaries that lack objectivity or fail to capture the discussion's nuances and action items accurately.

### Lack of Real-Time Documentation for Offline Meetings

Current solutions for meeting summarization largely cater to online platforms, leaving a significant gap when it comes to offline or in-person meetings. Participants of such meetings lack access to automated, real-time documentation tools, resulting in potential loss of valuable insights and decisions made during these discussions.

### Difficulty in Capturing Speaker-Specific Contributions

Identifying and attributing specific points to individual speakers in meeting summaries can be challenging, especially in discussions involving multiple participants. This limitation makes it difficult to track responsibilities, follow-ups, and the context of each contribution.

### Inadequate Personalization and Context Awareness in Summaries

Existing summarization technologies often generate generic summaries that do not account for the specific interests or information needs of individual participants. Moreover, they may lack the ability to adjust summaries based on the meeting's context, type, or specific industry jargon, leading to summaries that might not fully capture the essence of the discussion.

### Challenges in Continuous Improvement and Adaptation

Many existing summarization tools do not incorporate mechanisms for continuous learning from new data, which limits their ability to improve accuracy over time, adapt to evolving language use, or refine personalization features based on user feedback.

### Privacy and Data Security Concerns

Capturing and processing audio recordings for meeting summarization raises significant privacy and data security concerns. Solutions must ensure that data is handled securely, with adequate consent mechanisms and compliance with data protection regulations, to protect participant privacy.

Integration with Workflow and Productivity Tools

The lack of seamless integration between meeting summarization tools and other workflow or productivity platforms can hinder the efficient use of generated summaries. Users need tools that can easily connect with project management software, calendars, and communication platforms to enhance utility and accessibility.

Accordingly, our inventive systems and methods advantageously address these challenges by offering an advanced, user-friendly solution that leverages AI to provide accurate, personalized meeting summaries across various settings, enhancing productivity, accountability, and knowledge management. By harnessing the power of Large Language Models (LLMs) enhanced with continuous learning capabilities, this portable device offers real-time, accurate transcription and summarization of meetings, regardless of their setting. It features advanced speaker recognition technology to attribute contributions accurately, ensuring clarity in action items and responsibilities. The device stands out for its ability to adapt and improve over time, learning from each interaction to enhance summary relevance and accuracy. Furthermore, it prioritizes privacy and data security, integrating seamlessly with existing workflow and productivity tools to provide personalized, context-aware summaries directly accessible to all participants. This invention not only solves the inefficiencies and limitations of current meeting summarization tools but also sets a new standard in meeting documentation technology, making it an indispensable tool for professionals across various industries

As will now be apparent to those skilled in the art, our inventive systems and methods when applied to this meeting domain incorporates several inventive features designed to address the specific challenges associated with meeting documentation, particularly for offline settings. These features not only solve existing problems but also advance the state of the art in meeting summarization technology.

Advanced LLM with Domain Adaptation

We utilize state-of-the-art Transformer-based Large Language Models (LLMs) that are further enhanced through domain adaptation. This allows the device to provide highly accurate speech-to-text conversion and contextual summarization tailored to specific fields, and improves the relevance and precision of summaries for specialized discussions. This feature overcomes the limitations of generic summarization tools by ensuring that the summaries are contextually aligned with the domain-specific terminology and nuances of the discussion.

### Continuous Learning Mechanism

We feature a sophisticated continuous learning framework that enables the device to learn from new data and user feedback over time. This mechanism allows for the dynamic updating of LLM models, ensuring the summarization capabilities evolve and improve with use. By doing this, we address the challenge of adapting to evolving language and meeting contexts, enhancing the device's accuracy and personalization capabilities over time.

### Speaker Recognition and Differentiation

We incorporate advanced speaker recognition technology to accurately identify and differentiate between speakers during a meeting. This allows for precise attribution of statements and action items in the generated summaries. This also solves the problem of attributing dialogue in multi-speaker settings, ensuring clear responsibility and follow-up actions are identified in the summaries.

### Personalized Summarization

We employ AI algorithms to generate personalized summaries based on the user's role, preferences, and the specific context of the meeting. This personalization extends to adapting the summary's focus and detail level to match the user's needs. This also eliminates the issue of one-size-fits-all summaries by providing tailored insights, making the summaries more actionable and relevant to each user.

### Offline Functionality and Portability:

Our device is designed to be fully functional in offline settings, the device does not rely on cloud processing for its core operations. Its portable design makes it suitable for use in various environments, from formal boardrooms to informal gatherings. This bridges the gap left by online platform-dependent solutions, offering a versatile tool for meeting documentation that is not limited by internet connectivity.

### Privacy and Security Measures

We prioritize user privacy and data security through encrypted storage and transmission of meeting data, along with robust consent mechanisms. This feature is crucial for compliance with data protection regulations. Mitigates privacy and security concerns associated with meeting recordings and summaries, fostering trust and wider adoption of the technology.

### Seamless Workflow Integration:

Our innovative systems, methods, and devices offer seamless integration with existing productivity and workflow tools through API connections. This allows for the automated dissemination of meeting summaries into users' existing digital ecosystems. This also enhances the utility of summaries by making them easily accessible and actionable within the tools users already employ for task management and decision-making. By integrating these inventive features, our systems, and methods offers a comprehensive solution to the challenges of meeting documentation, setting a new benchmark in efficiency, accuracy, and personalization for offline and in-person meeting contexts

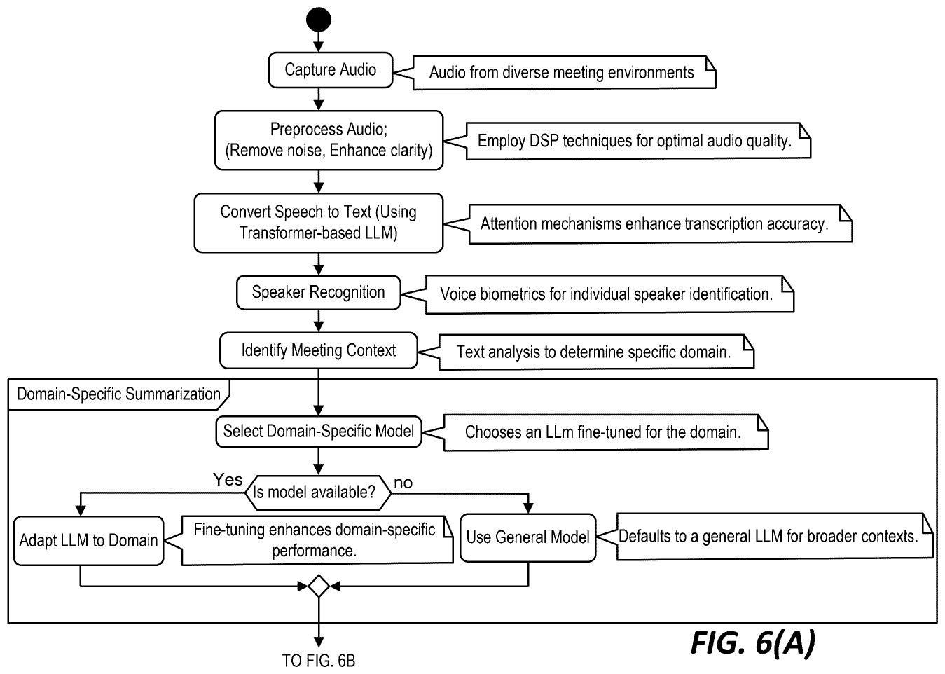

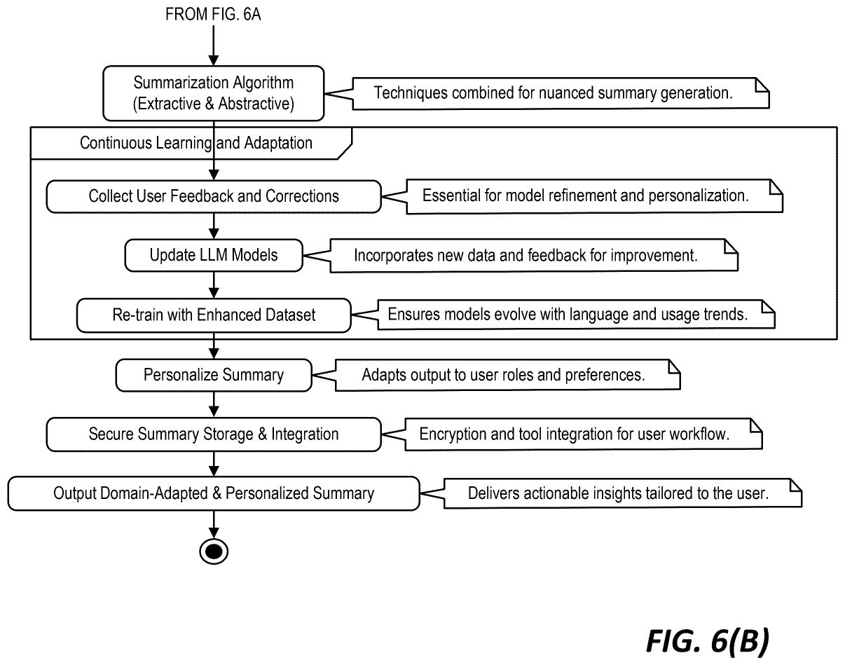

FIG. 6(A) and FIG. 6(B) are schematic flow diagrams showing illustrative method steps according to aspects of the present disclosure.

The Step-by-Step description of our invention is presented as follows.

### Step 1: Audio Capture

The device starts by capturing audio from the meeting or conversation using an advanced microphone array designed for clear audio pickup in diverse environments.

### Step 2: Audio Preprocessing

The preprocessing step is critical for ensuring that the audio is in the best possible form for transcription, addressing the initial challenge of capturing high-quality audio data in offline settings. In this step, we utilize digital signal processing (DSP) techniques to enhance audio quality. This includes noise reduction algorithms to filter out background noise and echo cancellation to ensure clarity of speech.

### Step 3: Speech-to-Text Conversion Using Transformer-Based LLMs

This step utilizes Transformer-based Large Language Models (LLMs), specifically chosen for their ability to process sequential data and understand context within language. The conversion process employs a self-attention mechanism that allows the model to weigh the importance of each word in the speech input, enhancing transcription accuracy. The self-attention mechanism can be represented as:

$$Attention ( Q , K , V ) = softmax ( \frac{{QK}^{T}}{\sqrt{{d}_{k}}} ) V$$

where QQ, KK, VV are the queries, keys, and values matrices derived from the input, and ddₖₖ is the dimension of the keys.

### Step 4: Meeting Context Identification

The device analyzes the transcribed text to identify keywords and phrases that indicate the meeting's domain or context (e.g., medical, legal, engineering).

Step 5: LLM-Powered Summarization with Domain Adaptation

Upon identifying the meeting's context, the device selects an appropriate domain-specific model that has been fine-tuned on relevant datasets. The domain adaptation enhances the model's proficiency in handling specialized terminology and nuances. The adaptation process involves Transfer Learning, where the general LLM is fine-tuned, fine-tuning for domain adaptation involves optimizing the model on a domain-specific dataset Ds, adjusting parameters ϑ to minimize loss.

The fine-tuning optimization process can be expressed in the following:

$${min}_{{θ}^{′}} L ( {D}_{s} , θ , {θ}^{′} )$$

where L is the loss function tailored for the domain-specific dataset.

### Step 6: Advanced Summarization Techniques

The summarization step employs both extractive and abstractive summarization techniques. Extractive summarization identifies and compiles the most important sentences from the text directly. In contrast, abstractive summarization generates new sentences that summarize the original content, capturing the essence with fewer words. For abstractive summarization, a sequence-to-sequence (Seq2Seq) model with an encoder-decoder structure can be used. The encoder processes the input text into a context vector, while the decoder generates the summary
Summary=Decoder (Encoder (Input))

This model may employ an attention mechanism to improve focus on relevant parts of the input text during summary generation.

### Step 7: Speaker Recognition and Attribution

In this step, we use sophisticated speaker recognition technology to distinguish between speakers. This feature employs audio signal processing to extract unique vocal features from each speaker, enabling accurate attribution of dialogue in meeting summaries. Machine learning models, potentially Convolutional Neural Networks (CNNs) or Recurrent Neural.

Networks (RNNs), analyze audio features to identify and differentiate speakers based on their unique voice signatures.

### Step 8: Continuous Learning and Adaptation

In this step, the continuous learning framework of the device systematically collects anonymized user feedback and corrections, alongside emerging terminologies from diverse meeting contexts. This collected data is crucial for identifying common errors, user preferences, and evolving language patterns, serving as the foundation for model improvement. Utilizing advanced data analysis and machine learning algorithms, the device analyzes this data to pinpoint specific areas for enhancement within the LLM models.

Periodic re-training of the LLM models incorporates the updated dataset-enriched with new terminologies and refined based on user feedback-employing transfer learning techniques to fine-tune the models for better accuracy and relevance. This process involves adjusting model parameters to optimize performance while retaining previously learned information. The updated models are then seamlessly deployed to the device via over-the-air updates, ensuring users benefit from continuous improvements in summarization accuracy and personalization without manual intervention. Personalization algorithms further tailor the summary output to each user's preferences and roles, enhancing the device's utility and user satisfaction over time.

### Step 9: Personalization and Output

The final summary is tailored based on user-defined preferences and roles, ensuring that the output meets the specific information needs of the user. We address the issue of generic summaries by providing personalized insights, leveraging the device's personalization and context awareness capabilities.

### Step 10: Secure Storage and Integration

In this step, summaries are encrypted and stored securely on the device or transmitted to a designated storage solution. The device offers seamless integration with existing productivity tools for easy access and use within digital workflows. We prioritize privacy and data security while ensuring the summaries are readily accessible and integrated into users' workflows, enhancing the device's utility in task management and decision-making processes.

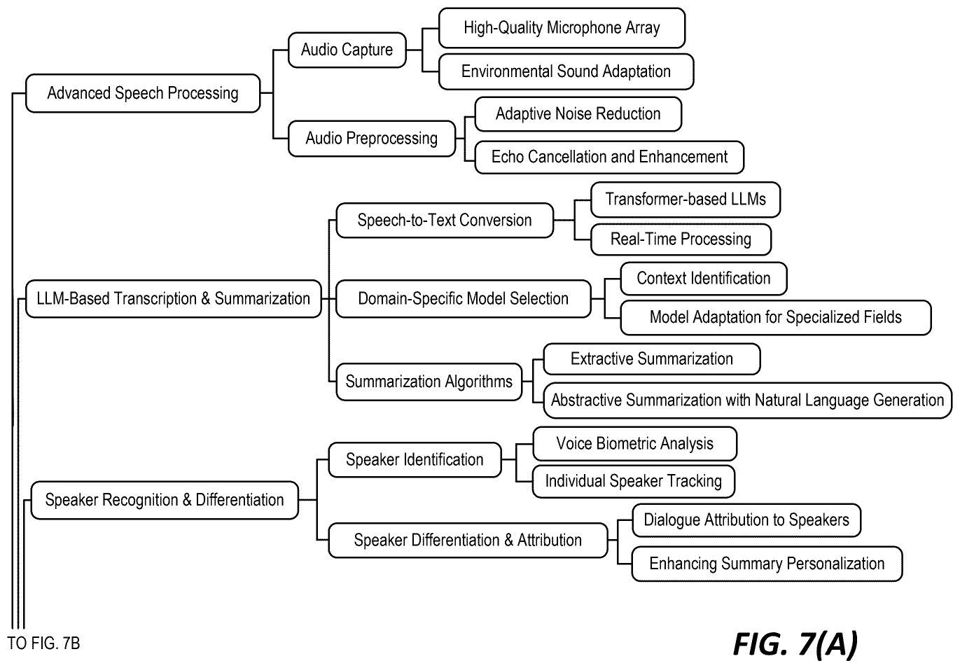

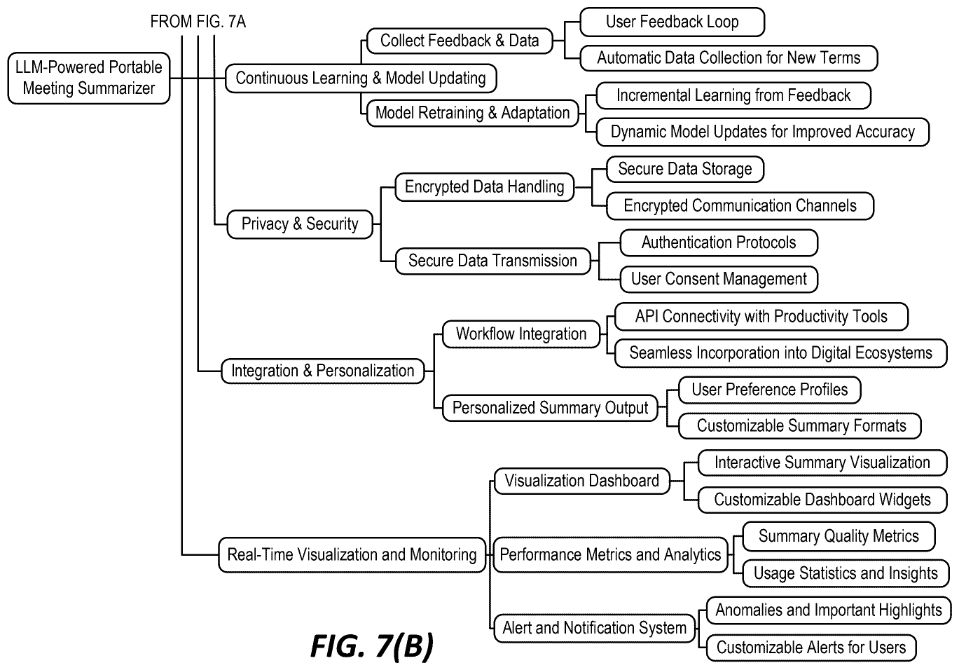

FIG. 7(A) and FIG. 7(B) show illustrative features in a hierarchical format of additional systems and methods according to aspects of the present disclosure.

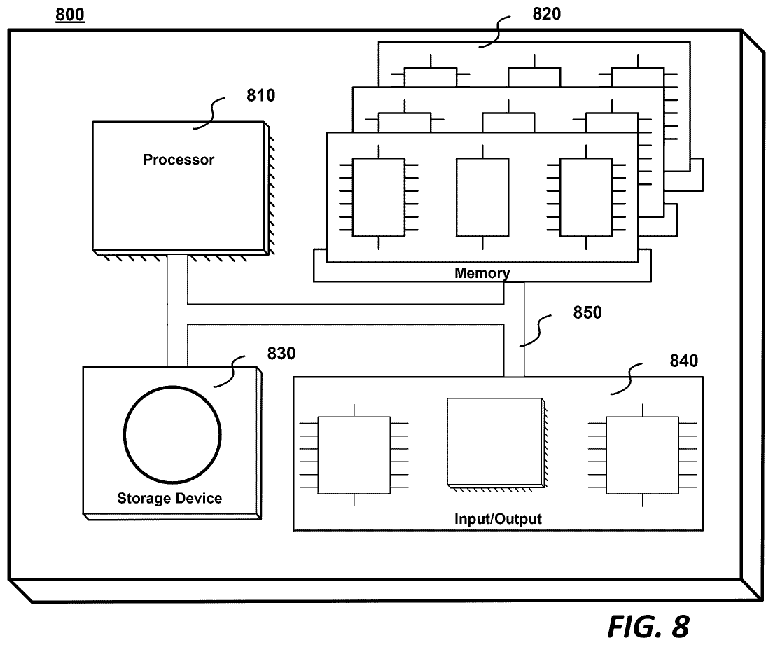

FIG. 8 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 800 as stored program control instructions.

Computer system 800 includes processor 810, memory 820, storage device 830, and input/output structure 840. One or more input/output devices may include a display 845. One or more busses 850 typically interconnect the components, 810, 820, 830, and 840. Processor 810 may be a single or multi core. Additionally, the system may include accelerators etc., further comprising the system on a chip.

Processor 810 executes instructions in which embodiments of the present disclosure may comprise steps described in one or more of the Drawing figures. Such instructions may be stored in memory 820 or storage device 830. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 830 may be a flash memory device, a disk drive, an optical disk device, or a tape device employing magnetic, optical, or other recording technologies.

Input/output structures 840 may provide input/output operations for system 800.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A large language model (LLM) voice-to-data documentation system for field inspection and infrastructure assessment comprising a processor configured, at least in part to:
capture voice data produced by field technicians resulting from an inspection and narration of observations;
converting, in real-time, the voice data to text using the LLM;
contextually analyzing the converted text and extracting information and insights; and
generating a compliance report using the extracted information and insights.

2. The system of claim 1, wherein the processor is further configured employ one of a cloud-based LLM or a local LLM to perform the real-time conversion of the voice data to text.

3. The system of claim 2 wherein the processor is further configured to adaptively reduce environmental noise for voice data capturing.

4. The system of claim 3 wherein the processor is further configured to encrypt the compliance report and summaries of same for transmission to a remote storage or local storage.

5. The system of claim 4 wherein the processor is further configured to receive feedback and enhance the LLM.
